(19) United States
(12) Patent Application Publication
(10) Pub. No.: US 2019/0104564 A1
(43) Pub. Date: Apr. 4, 2019

(54) Conditional RRC Confirm Messaging In Wireless Communications

(71) Applicant: MediaTek Inc., Hsinchu City (TW)

(72) Inventors: Per Johan Mikael Johansson, Kungsängen (SE); Shiang-Jiun Lin, Hsinchu City (TW); Li-Chuan Tseng, Hsinchu City (TW); Gilles Charbit, Hampshire (GB)

(21) Appl. No.: 16/144,097

(22) Filed: Sep. 27, 2018

Related U.S. Application Data
(60) Provisional application No. 62/565,213, filed on Sep. 29, 2017.

(51) Int. Cl. H04W 76/27; H04W 76/19; H04W 76/30; H04W 88/02

(52) U.S. Cl. CPC H04W 76/27; H04W 76/19; H04L 5/0055; H04W 88/023; H04W 76/30

(57) ABSTRACT

Various examples and schemes pertaining to conditional radio resource control (RRC) confirm messaging are described. A user equipment (UE) communicates with a network node of a wireless network. In communicating with the network node, the UE transmits a first message to the network node and receives a second message from the network node responsive to the transmitting of the first message. The UE also determines whether to transmit a third message to the network node acknowledging receipt of the second message. That is, transmission of the third message as a confirmation of receipt of the second message is conditional or otherwise optional so as to reduce signaling overhead.

### CROSS REFERENCE TO RELATED PATENT APPLICATION(S)

The present disclosure is part of a non-provisional application claiming the priority benefit of U.S. Patent Application No. 62/565,213, filed on 29 Sep. 2017, the content of which is incorporated by reference in its entirety.

### TECHNICAL FIELD

The present disclosure is generally related to wireless communications and, more particularly, to conditional radio resource control (RRC) confirm messaging in wireless communications.

### BACKGROUND

Unless otherwise indicated herein, approaches described in this section are not prior art to the claims listed below and are not admitted as prior art by inclusion in this section.

To support highly optimized communication systems such as Narrowband Internet of Things (NB-IoT) or Machine Type Communications (MTC)-optimized Long-Term Evolution (LTE), new ways for more aggressive reduction in signaling overhead would be desired so as to reduce signaling to prolong the battery life for a user equipment (UE). As requirements for low-battery consumption is sharpened, every transmission is potentially significant.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure proposes a number of schemes, solutions, techniques, methods and apparatuses pertaining to conditional RRC confirm messaging in wireless communications. It is believed that the proposed schemes, solutions, techniques, methods and apparatuses would result in reduced signaling overhead, thereby improving overall system performance and increasing batter life for UEs.

In one aspect, a method may involve a processor of a user equipment (UE) communicating with a network node of a wireless network. In communicating with the network node, the method may involve the processor transmitting a first message to the network node and receiving a second message from the network node responsive to the transmitting of the first message. The method may also involve the processor determining whether to transmit a third message to the network node acknowledging receipt of the second message.

In one aspect, an apparatus may include a transceiver and a processor coupled to the transceiver. The transceiver may be capable of wirelessly communicating with a network node of a wireless network. The processor may be capable of: (a) transmitting, via the transceiver, a first message to the network node; (b) receiving, via the transceiver, a second message from the network node responsive to the transmitting of the first message; and (c) determining whether to transmit a third message to the network node acknowledging receipt of the second message.

It is noteworthy that, although description provided herein may be in the context of certain radio access technologies, networks and network topologies such as IoT and NB-IoT, the proposed concepts, schemes and any variation(s)/derivative(s) thereof may be implemented in, for and by other types of radio access technologies, networks and network topologies such as, for example and without limitation, 5^{th} Generation, New Radio (NR), Long-Term Evolution (LTE), LTE-Advanced, LTE-Advanced Pro. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario of a three-way handshake procedure.

FIG. 2A is a diagram of an example scenario of establishing an RRC connection for control plane (CP) cellular IoT (CIoT) Evolved Packet System (EPS) optimizations.

FIG. 2B is a diagram of an example scenario of establishing an RRC connection for user plane (UP) CIoT EPS optimizations.

FIG. 3 is a diagram of an example scenario of a two-way handshake procedure in accordance with an implementation of the present disclosure.

FIG. 4A is a diagram of an example early data transmission procedure for CP CIoT EPS optimizations in accordance with an implementation of the present disclosure.

FIG. 4B is a diagram of an example early data transmission procedure for UP CIoT EPS optimizations in accordance with an implementation of the present disclosure.

FIG. 5 is a block diagram of an example communication environment in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to conditional RRC confirm message in wireless communications for reduction in signaling overhead and improvement in system performance. According to the present disclosure, a number of possible solutions may be implemented separately or jointly. That is, although these possible solutions may be described below separately, two or more of these possible solutions may be implemented in one combination or another.

In current 3^{rd}-Generation Partnership Project (3GPP) systems, signaling procedures are specified with signaling robustness requirements in mind. Moreover, signaling procedures are pre-classified and hard-coded into one way indication procedures, two-way procedures and/or three-way procedures with a two-way interaction plus confirm messages. In current systems, information optionality is modeled as the absence or presence of information elements in particular signaling messages. Furthermore, in current systems, the very first messages exchanged to set up and configure a signaling connection typically use very simple pre-configured fixed means and are dimensioned according to the worst-case scenario. That is, the very first messages exchanged to set up and configure a signaling connection are fixed in size in order to handle the very worst radio conditions. However, there is an issue that current principles, designs and approaches tend to result in a multitude of messages, thereby resulting in undesirable signaling overhead.

The current RRC connection setup or connection resume procedure according to the 3GPP specifications is a three-way procedure that is applied in the access phase of a communication between a UE and a base station (e.g., eNodeB or gNB) of a wireless network (e.g., LTE or 5G/NR mobile network). This procedure typically involves the following steps between the UE and the base station:
1. From UE to base station (Message 3): RRC connection setup request (CP CIoT EPS optimization) or RRC connection resume request UP CIoT EPS optimization);
2. From base station to UE (Message 4): RRC connection setup or RRC connection resume; and
3. From UE to base station (Message 5): RRC connection setup confirm or RRC connection resume confirm.

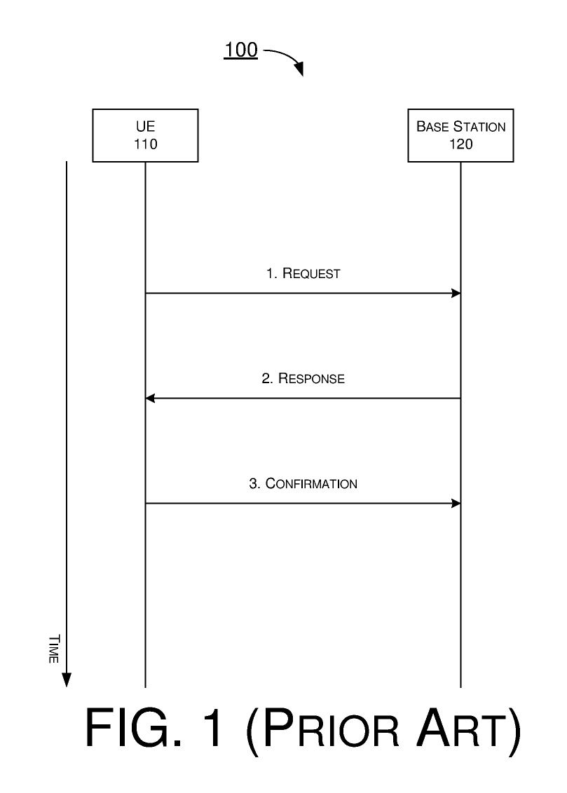

FIG. 1 illustrates an example scenario 100 of a three-way handshake procedure between a UE 110 and a base station 120. In scenario 100, UE 310 transmits a request (Message 3) to base station 320 and, upon receiving a response (Message 4) from base station 320 (e.g., granting the request), UE 310 transmits a confirm message (Message 5).

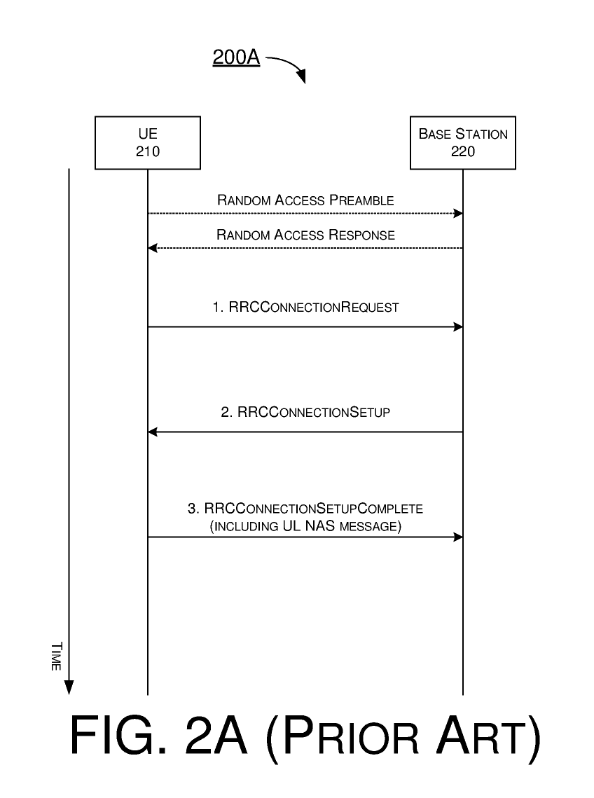

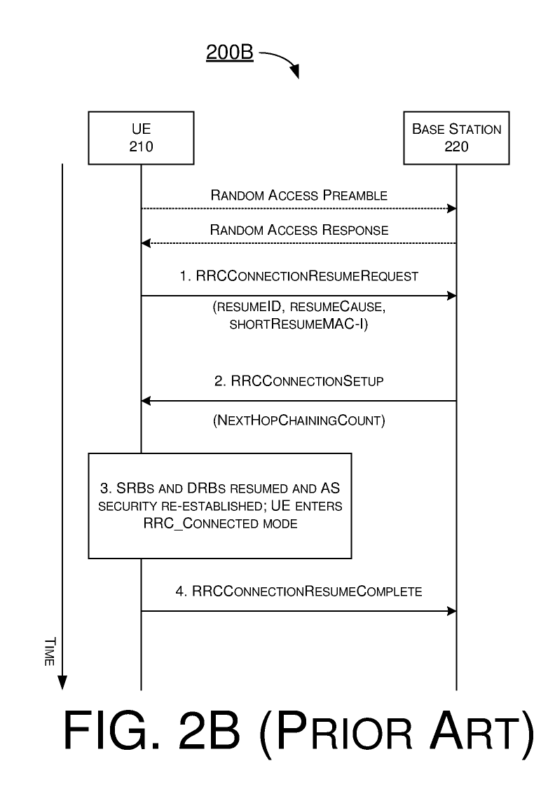

FIG. 2A illustrates an example scenario 200A of establishing an RRC connection for CP CIoT EPS optimizations. Referring to FIG. 2A, procedure 200A involves the following steps with respect to a UE 210 and a base station 220:
0. UE 210 sends a random access preamble to base station 220, which responds with a random access response.
1. UE 210 sends base station 220 an RRCConnectionRequest message.
2. Base station 220 sends UE 210 an RRCConnectionSetup message.
3. UE 210 sends base station 220 an RRCConnectionSetupComplete message (including UL non-access stratum (NAS) message).

FIG. 2B illustrates an example scenario 200B of establishing an RRC connection for UP CIoT EPS optimizations. Referring to FIG. 2B, procedure 200B involves the following steps with respect to UE 210 and base station 220:
0. UE 210 sends a random access preamble to base station 220, which responds with a random access response.
1. UE 210 sends base station 220 an RRCConnectionResumeRequest message (including resume ID, resume cause, and an authentication token (shortResumeMAC-I)).
2. Base station 220 sends UE 210 an RRCConnectionResume message (including NextHopChainingCount).
3. UE 210 resumes all signaling radio bearers (SRBs) and data radio bearers (DRBs), re-establishes the access stratum (AS) security, and enters RRC_Connected mode.
4. UE 210 sends base station 220 an RRCConnectionResumeComplete message.

Before Message 3, the UE needs to send a preamble (Message 1) to the base station and receive a random access response (Message 2) from the network via the base station.

The RRC connection request message, sent from the UE to the base station, carries information such as the identification of the UE (UE-ID), establishment cause, multi-tone support information, and multi-carrier support information. The RRC connection setup message, sent from the base station to the UE, carries information such as dedicated RRC configuration. The RRC connection resume request message, sent from the UE to the base station, carries information such as resume ID, resume cause, and a message authentication token (shortResumeMAC-I). The RRC connection resume message, sent from the base station to the UE, carries information such as dedicated RRC configuration, security control information, and an indication as to whether to continue or reset a header compression protocol context for the data radio bearers (DRBs) by drb-ContinueROHC.

### Continued RRC Confirm Messaging

In the messaging in the third step shown above (Message 5), for Control Plane CIoT EPS Optimizations, the UE responds with an RRCConnectionSetupComplete confirming that the RRC connection was setup successfully, along with NAS PDU containing Service Request and/or uplink user data. For User Plane CIoT EPS Optimizations, the UE responds with an RRCConnectionResumeComplete confirming that the RRC connection was resumed successfully, along with an uplink Buffer Status Report, and/or UL data, whenever possible, to the base station.

Under a proposed scheme in accordance with the present disclosure, for machine-to-machine (M2M) systems that require a higher degree of optimization, messaging in the third step shown above (Message 5) may be treated as optional, thereby reducing the number of transmissions from a UE to a base station as well as between the UE and the base station as long as the essential information transmitted in Message 5 can be transmitted in Message 3.

The proposed scheme is flexible and can adapt to different radio conditions and different radio transport block sizes. Specifically, under the proposed scheme, the first request message (Message 3) merely needs to carry the information most commonly used such as, for example and without limitation, the “normal” UE identity for an attached UE, System Architecture Evolution (SAE) temporary mobile subscriber identity (S-TMSI) or, for a suspended UE, resume ID plus message authentication token (shortResumeMAC-I), and UL data. Moreover, under the proposed scheme, the confirm message (Message 5) merely needs to carry optional information and additional UE addressing information used for particular cases when the basic information in the request message is not sufficient. It can depend on the indication in Message 4 for the UE to determine whether to transmit Message 5 or not. For instance, under the proposed scheme, the UE may transmit the confirm message (Message 5) when the UE changes to a base station that is connected to another part of the core network(s).

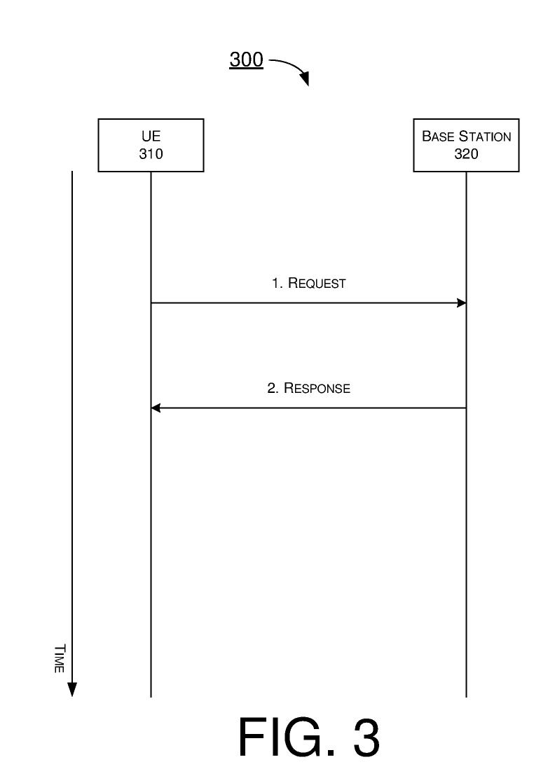

Under the proposed scheme, the base station may determine when additional information is needed from the UE such that a confirm message (Message 5) would need to be transmitted by the UE to provide such additional information. Accordingly, the base station may request for such information or the confirm message explicitly. It is believed that the proposed scheme would be particularly useful when other enhancements are applied. For instance, when pieces of data can be transmitted together with signaling with a request (in the uplink (UL) direction) and/or setup/resume messages (in the downlink (DL) direction), the entire connected mode “session” may be concluded with two (or three) main transmissions. FIG. 3 illustrates an example scenario 300 of a generic two-way handshake procedure between a UE 310 and a base station 320 in accordance with an implementation of the present disclosure. In scenario 300, UE 310 transmits a request (Message 3) to base station 320 and, upon receiving a response (Message 4) from base station 320 (e.g., granting the request), UE 310 may determine that there is no need to transmit a confirm message. Thus, no confirm message (Message 5) is sent in scenario 300.

It is also noteworthy that the penalty or cost associated with adding some information to a radio transmission that needs to occur anyway would be much less than creating a dedicated transmission for said information. Thus, opportunistically, in an event that an UL transmission needs to be performed anyway after Message 3 and Message 4 (e.g., for data or higher-layer signaling such as NAS or Internet Protocol (IP) Multimedia Subsystem (IMS) signaling), for example, the UL data cannot be transmitted in Message 3 due to limited size of Message 3, a confirm message may be sent by the UE in accordance with the proposed scheme of the present disclosure.

To aid better appreciation of the proposed scheme, illustrative and non-limiting examples of skipping the RRC confirm message are provided below in the context of early data transmission (EDT).

### EDT for Control Plane CIoT EPS Optimizations

EDT for CP CIoT EPS optimizations is characterized as follows:
Uplink user data are transmitted in a NAS message concatenated in a UL RRCEarlyDataRequest message on a Common Control Channel (CCCH);
Downlink user data are optionally transmitted in a NAS message concatenated in a DL RRCEarlyDataComplete message on CCCH; and
There is no transition to RRC Connected.

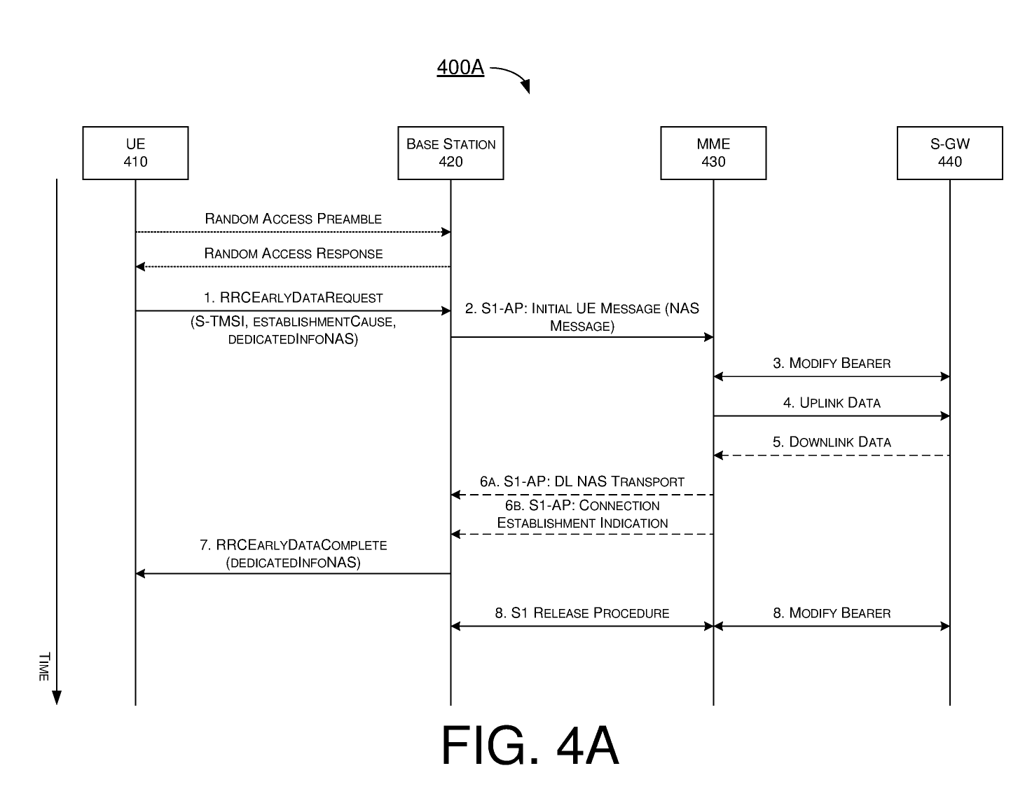

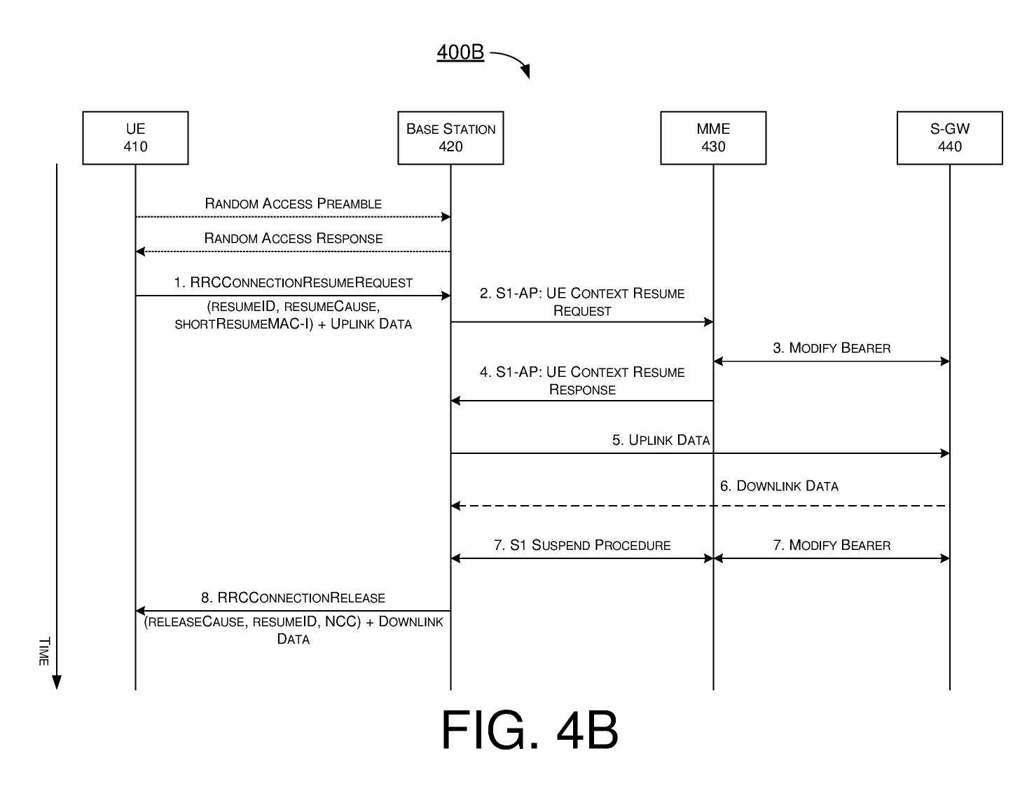

FIG. 4A illustrates an example EDT procedure 400A for CP CIoT EPS optimizations in accordance with an implementation of the present disclosure. Referring to FIG. 4A, procedure 400A involves the following steps with respect to a UE 410, a base station 420, a mobile management entity (MME) 430 and a serving gateway (S-GW) 440:
0. Upon connection establishment request for Mobile Originated data from the upper layers, UE 410 initiates the EDT procedure and selects a random access preamble configured for EDT.
1. UE 410 sends a RRCEarlyDataRequest message concatenating the user data on CCCH.
2. Base station 420 initiates the S1-AP Initial UE message procedure to forward the NAS message and establish the S1 connection, and base station 420 may indicate in this procedure that this connection is triggered for EDT.
3. MME 430 requests S-GW 440 to re-activate the EPS bearers for UE 410.
4. MME 430 sends the uplink data to S-GW 440.
5. If downlink data are available, S-GW 440 sends the downlink data to MME 430.
6. If downlink data are received from S-GW 440, then MME 430 forwards the data to base station 420 via a DL NAS Transport procedure and may also indicate whether further data are expected. Otherwise, MME 430 may trigger a Connection Establishment Indication procedure and also indicate whether further data are expected.
7. If no further data are expected, base station 420 can send the RRCEarlyDataComplete message on CCCH to keep UE 410 in RRC_IDLE. If downlink data were received in step 6, they are concatenated in RRCEarlyDataComplete message.
8. The S1 connection is released and the EPS bearers are deactivated.

It is noteworthy that, in an event that MME 430 or base station 420 decides to move UE 410 into RRC_Connected mode, a RRCConnectionSetup message may be sent in step 7 to fall back to the legacy RRC Connection establishment procedure. The base station 420 may discard the zero-length NAS protocol data unit (PDU) received in Message 5.

Thus, base station 420 may transmit either of two messages to UE 410 when base station 420 receives the RRC EarlyDataComplete message from UE 410. In an event that a two-way handshake procedure is followed, base station 420 may send UE 410 RRCEarlyDataComplete in its response message to UE 410. However, in an event that base station 420 decides to turn UE 410 to RRC_connected mode, base station 420 may send UE 410 RRCConnectionSetup in its response message to UE 410. The difference between RRCEarlyDataComplete and RRCConnectionSetup is not just in an IE but the content carried and/or format may also be different. Whether RRCEarlyDataComplete or RRCConnectionSetup is transmitted in the response message from base station 420 to UE 410, an indication is provided in a DL CCCH message.

The RRCEarlyDataComplete message may be used to confirmed successful completion of the CP EDT procedure when UE 410 has no RRC connection. As an illustrative and non-limiting example, an RRCEarlyDataComplete message may be as follows:

```
-- ASN1START
RRCEarlyDataComplete-r15 ::= SEQUENCE {
  criticalExtensions CHOICE {
    c1 CHOICE {
      rrcEarlyDataComplete-r15 RRCEarlyDataComplete-r15-
IEs,
      spare1 NULL
    },
    criticalExtensionsFuture SEQUENCE { }
  }
}
RRCEarlyDataComplete-r15-IEs ::= SEQUENCE {
  dedicated InfoNAS-r15 Dedicated InfoNAS
OPTIONAL, -- Need ON
  extendedWaitTime-r15 INTEGER (1..1800)
OPTIONAL, -- Need ON
  idleModeMobilityControlInfo-r15 IdleModeMobilityControlInfo
OPTIONAL, -- Need OP
  idleModeMobilityControlInfoExt-r15 IdleModeMobilityControlInfo-
v9e0 OPTIONAL, -- Cond IdleInfoEUTRA
  redirectedCarrierInfo-r15 RedirectedCarrierInfo-r15-IEs
OPTIONAL, -- Need ON
  nonCriticalExtension SEQUENCE { }
OPTIONAL
}
RedirectedCarrierInfo-r15-IEs ::= CHOICE {
  eutra-r15 ARFCN-ValueEUTRA-r9,
  geran-r15 CarrierFreqsGERAN,
  utra-FDD-r15 ARFCN-ValueUTRA,
  cdma2000-HRPD-r15 CarrierFreqCDMA2000,
  cdma2000-1xRTT-r15 CarrierFreqCDMA2000,
  utra-TDD-r15 CarrierFreqListUTRA-TDD-r10
}
-- ASN1STOP
```

The RRCConnectionSetup message may be used to establish SRB1 and SRB1bis. As an illustrative and non-limiting example, an RRCConnectionSetup message may be as follows:

```
-- ASN1START
RRCConnectionSetup-NB ::= SEQUENCE {
  rrc-TransactionIdentifier RRC-TransactionIdentifier,
  criticalExtensions CHOICE {
    c1 CHOICE {
      rrcConnectionSetup-r13 RRCConnectionSetup-NB-r13-
IEs,
      spare1 NULL
    },
    criticalExtensionsFuture SEQUENCE { }
  }
}
RRCConnectionSetup-NB-r13-IEs ::= SEQUENCE {
  radioResourceConfigDedicated-r13
RadioResourceConfigDedicated-NB-r13,
  lateNonCriticalExtension OCTET STRING
OPTIONAL,
  nonCriticalExtension SEQUENCE { }
OPTIONAL
}
-- ASN1STOP
```

The DL CCCH message class may include a set of RRC messages that may be sent from base station 420 to UE 410 on the DL CCCH logical channel. As an illustrative and non-limiting example, a DL CCCH message may be as follows:

```
-- ASN1START
DL-CCCH-Message ::= SEQUENCE {
  message DL-CCCH-MessageType
}
DL-CCCH-MessageType ::= CHOICE {
  c1 CHOICE {
    rrcConnectionReestablishment
RRCConnectionReestablishment,
    rrcConnectionReestablishmentReject
RRCConnectionReestablishmentReject,
    rrcConnectionReject RRCConnectionReject,
    rrcConnectionSetup RRCConnectionSetup
  },
  messageClassExtension CHOICE {
    c2 CHOICE {
      rrcEarlyDataComplete-r15 RRCEarlyDataComplete-r15,
      spare NULL
    },
    messageClassExtensionFuture-r15 SEQUENCE { }
  }
}
-- ASN1STOP
```

### EDT for User Plane CIoT EPS Optimizations

EDT for UP CIoT EPS optimizations is characterized as follows:
The UE has been provided with a NextHopChainingCount in a RRCConnectionRelease message with suspend indication;
Uplink user data are transmitted on a Dedicated Traffic Channel (DTCH) multiplexed with a UL RRCConnectionResumeRequest message on CCCH; and
Downlink user data are optionally transmitted on DTCH multiplexed with a DL RRCConnectionRelease message on a Dedicated Control Channel (DCCH).

FIG. 4B illustrates an example EDT procedure 400B for UP CIoT EPS optimizations in accordance with an implementation of the present disclosure. Referring to FIG. 4B, procedure 400B involves the following steps with respect to a UE 410, a base station 420, an MME 430 and a S-GW 440:
0. Upon connection resumption request for Mobile Originated data from the upper layers, UE 410 initiates the EDT procedure and selects a random access preamble configured for EDT.
1. UE 410 sends an RRCConnectionResumeRequest message to base station 420, including its Resume ID, the establishment cause, and an authentication token. UE 410 resumes all signaling radio bearers (SRBs) and data radio bearers (DRBs), derives new security keys using the NextHopChainingCount provided in the RRCConnectionRelease message of the previous connection and re-establishes the access stratum (AS) security. The user data are ciphered and transmitted on DTCH multiplexed with the RRCConnectionResumeRequest message on CCCH.
2. Base station 420 initiates the s1-AP Context Resume procedure to resume the S1 connection and re-activate the S1-U bearers.
3. MME 430 requests S-GW 440 to re-activate the S1-U bearers for UE 410.
4. MME 430 confirms the UE context resumption to base station 420.
5. The uplink data are delivered to S-GW 440.
6. If downlink data are available, S-GW 440 sends the downlink data to base station 420.
7. If no further data are expected from S-GW 440, base station 420 can initiate the suspension of the S1 connection and the deactivation of the S1-U bearers.
8. Base station 420 sends the RRCConnectionRelease message to keep UE 410 in RRC_IDLE. The message includes the releaseCause set to rrc-Suspend, the resumeID, the NextHopChainingCount and drb-ContinueROHC which are stored by UE 410. If downlink data were received in step 6, they are sent ciphered on DTCH multiplexed with the RRCConnectionRelease message on DCCH.

It is noteworthy that, in an event that MME 430 or base station 420 decides to move UE 410 in RRC_Connected mode, a RRCConnectionResume message may be sent in step 7 to fall back to the RRC Connection resume procedure. In such cases, the RRCConnectionResume message may be integrity protected and ciphered with the keys derived in step 1. Additionally, UE 410 may ignore the NextHopChainingCount included in the RRCConnectionResume message. Downlink data may be transmitted on DTCH multiplexed with the RRCConnectionResume message.

It is noteworthy that, in an event, for example, that UE context cannot be restored at base station and that MME or base station decides to establish RRC connection with UE, then a RRCConnectionSetup message may be sent to the RRC Connection resume procedure to fall back to the legacy RRC Connection establishment procedure. Then, the RRC Connection Setup Complete message may be sent from UE to base station.

### Illustrative Implementations

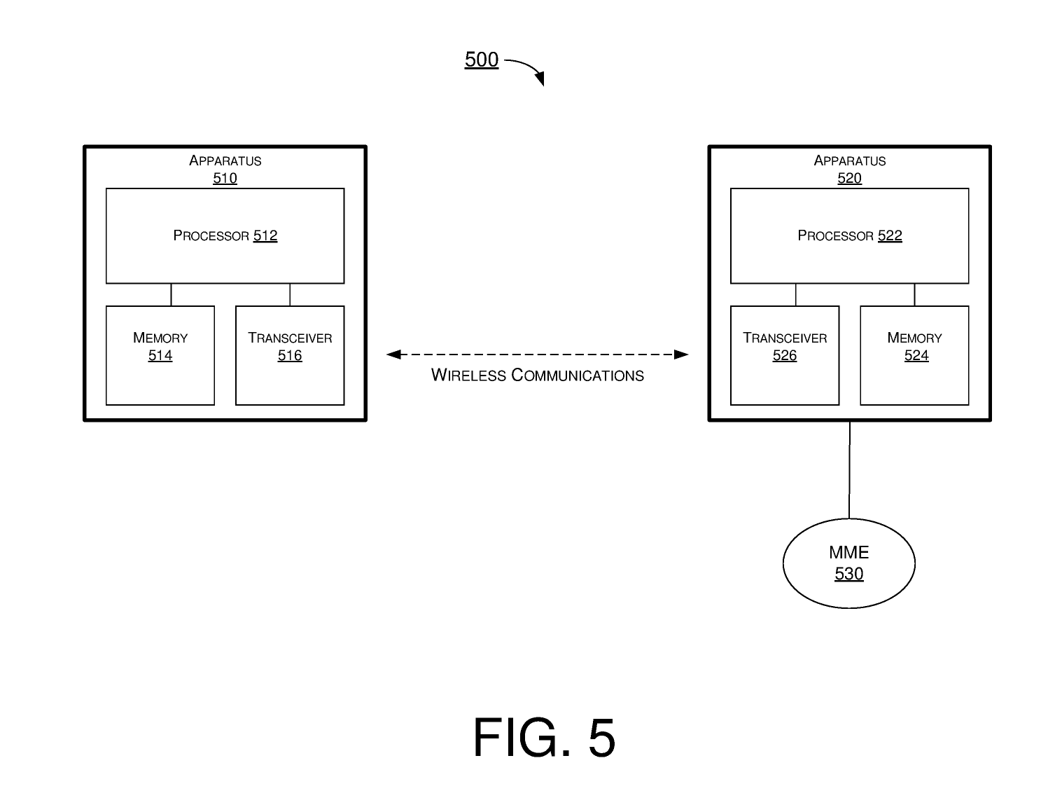

FIG. 5 illustrates an example communication environment 500 having an example apparatus 510 and an example apparatus 520 in accordance with an implementation of the present disclosure. Each of apparatus 510 and apparatus 520 may perform various functions to implement schemes, techniques, processes and methods described herein pertaining to conditional RRC confirm message in wireless communications for reduction in signaling overhead and improvement in system performance, including various schemes described above, such as scenarios 300, 400A and 400B, as well as process 600 described below. Apparatus 310 may be an example implementation of UE 410 described above. Apparatus 520 may be an example implementation of base station 420 described above.

Each of apparatus 510 and apparatus 520 may be a part of an electronic apparatus, which may be a UE such as a portable or mobile apparatus, a wearable apparatus, a wireless communication apparatus or a computing apparatus. For instance, each of apparatus 510 and apparatus 520 may be implemented in a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, or one or more complex-instruction-set-computing (CISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a network node such as a transmit/receive point (TRP), a base station, a small cell, a router or a gateway. For instance, at least one of apparatus 510 and apparatus 520 may be implemented in an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more CISC processors.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including conditional RRC confirm messaging in wireless communications for reduction in signaling overhead and improved system performance in accordance with various implementations of the present disclosure.

In some implementations, apparatus 510 may also include a transceiver 516 coupled to processor 512 and capable of wirelessly transmitting and receiving data. In some implementations, apparatus 510 may further include a memory 514 coupled to processor 512 and capable of being accessed by processor 512 and storing data therein. In some implementations, apparatus 520 may also include a transceiver 526 coupled to processor 522 and capable of wirelessly transmitting and receiving data. In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of a mobile communication environment in which apparatus 510 is implemented in or as a wireless communication device, a communication apparatus or a UE and apparatus 520 is implemented in or as a network node (e.g., base station) connected or otherwise communicatively coupled to an MME 530.

Under a proposed scheme in accordance with the present disclosure pertaining to conditional RRC confirm messaging, processor 512 of apparatus 510, as a UE, may communicate via transceiver 516 with network apparatus 520, as a network node. In communicating with network apparatus 520, processor 512 may transmit, via transceiver 516, a first message to network apparatus 520. Additionally, processor 512 may receive, via transceiver 516, a second message from apparatus 520 in response to the transmitting of the first message. Moreover, processor 512 may determine whether to transmit a third message to network apparatus 520 acknowledging receipt of the second message.

In some implementations, processor 512 may transmit, via transceiver 512, the third message that includes a confirm message confirming receipt of the second message responsive to a result of the determining indicating a request information element (IE) or a format in the second message. In some implementations, in transmitting the third message processor 512 may transmit the third message further responsive to the result of the determining also indicating that there is insufficient space in the first message to carry a piece of information requested in the request IE in addition to the confirm message.

In some implementations, processor 512 may transmit, via transceiver 512, the third message that includes a confirm message confirming receipt of the second message responsive to a result of the determining indicating a need for an UL transmission to network apparatus 520. In some implementations, in transmitting the third message processor 512 may transmit the third message further responsive to the result of the determining also indicating that there is sufficient space in the third message to carry data, higher-layer signaling, or both, in addition to the confirm message. Alternatively, in transmitting the third message processor 512 may transmit the third message responsive to the result of the determining indicating the need for the UL transmission due to the UE connecting to another network node that is connected to a different part of the wireless network.

In some implementations, processor 512 may transmit, via transceiver 512, the third message that includes a confirm message confirming receipt of the second message responsive to a result of the determining indicating it necessary to transmit the third message. In some implementations, the first message may include an RRC Connection Request message, the second message may include an RRC Connection Setup message, and the third message may include an RRC Connection Setup Complete message.

In some implementations, the first message may include an RRC Connection Resume Request message, the second message may include an RRC Connection Resume message, and the third message may include an RRC Connection Resume Complete message.

In some implementations, the first message may include an RRC Connection Resume Request message, the second message may include an RRC Connection Setup message, and the third message may include an RRC Connection Setup Complete message.

In some implementations, the first message may include an RRC Connection Early Data Request message, and the second message may include an RRC Early Data Complete message.

In some implementations, the first message may include an RRC Connection Resume Request message plus uplink data, and wherein the second message may include an RRC Connection Release message.

In some implementations, the first message may include an RRC Early Data Request message, the second message may include an RRC Connection Setup message, and the third message may include an RRC Connection Setup Complete message.

In some implementations, the first message may include an RRC Connection Resume Request message plus uplink data, the second message may include an RRC Connection Resume message, and the third message may include an RRC Connection Resume Complete message.

### Illustrative Processes

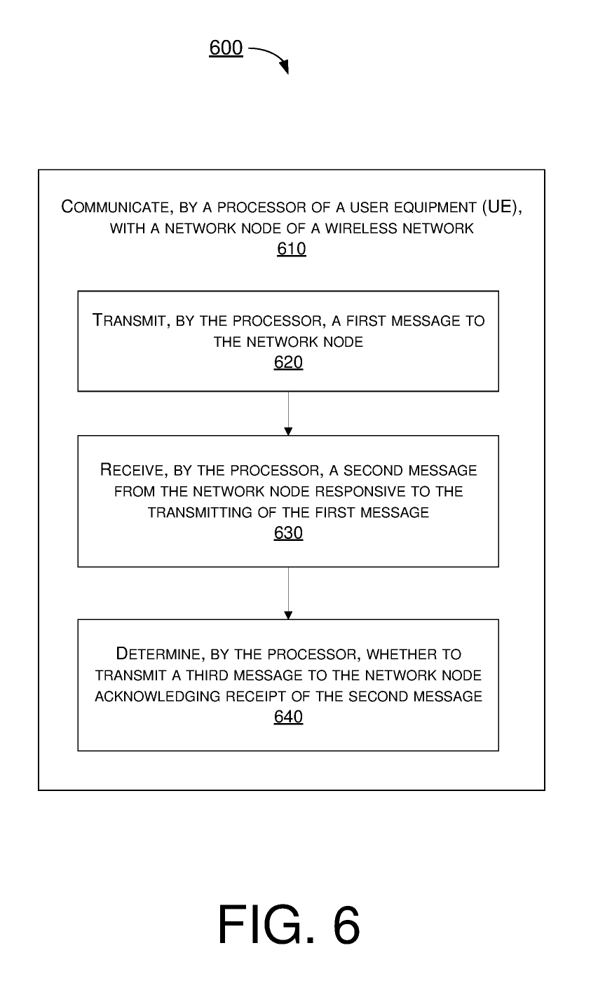

FIG. 6 illustrates an example process 600 in accordance with an implementation of the present disclosure. Process 600 may be an example implementation of the proposed schemes described above with respect to conditional RRC confirm message in wireless communications for reduction in signaling overhead and improvement in system performance in accordance with the present disclosure. Process 600 may represent an aspect of implementation of features of apparatus 510 and apparatus 520. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 510, apparatus 520 and/or any suitable wireless communication device, UE, base station or machine type devices. Solely for illustrative purposes and without limitation, process 600 is described below in the context of apparatus 510 as a UE and apparatus 520 as a network node (e.g., base station such as a gNB) of a wireless network (e.g., 5G/NR mobile network). Process 600 may begin at block 610.

At 610, process 600 may involve processor 512 of apparatus 510 as a UE communicating with network apparatus 520 as a network node. In communicating with network apparatus 520, process 600 may involve processor 512 performing a number of operations as represented by blocks 620, 630 and 640.

At 620, process 600 may involve processor 512 transmitting, via transceiver 516, a first message to network apparatus 520. Process 600 may proceed from 620 to 630.

At 630, process 600 may involve processor 512 receiving, via transceiver 516, a second message from apparatus 520 in response to the transmitting of the first message. Process 600 may proceed from 630 to 640.

At 640, process 600 may involve processor 512 determining whether to transmit a third message to network apparatus 520 acknowledging receipt of the second message.

In some implementations, process 600 may further involve processor 512 transmitting, via transceiver 512, the third message that includes a confirm message confirming receipt of the second message responsive to a result of the determining indicating a request information element (IE) or a format in the second message. In some implementations, in transmitting the third message process 600 may involve processor 512 transmitting the third message further responsive to the result of the determining also indicating that there is insufficient space in the first message to carry a piece of information requested in the request IE in addition to the confirm message.

In some implementations, process 600 may further involve processor 512 transmitting, via transceiver 512, the third message that includes a confirm message confirming receipt of the second message responsive to a result of the determining indicating a need for an UL transmission to network apparatus 520. In some implementations, in transmitting the third message process 600 may involve processor 512 transmitting the third message further responsive to the result of the determining also indicating that there is sufficient space in the third message to carry data, higher-layer signaling, or both, in addition to the confirm message. Alternatively, in transmitting the third message process 600 may involve processor 512 transmitting the third message responsive to the result of the determining indicating the need for the UL transmission due to the UE connecting to another network node that is connected to a different part of the wireless network.

In some implementations, process 600 may further involve processor 512 transmitting, via transceiver 512, the third message that includes a confirm message confirming receipt of the second message responsive to a result of the determining indicating it necessary to transmit the third message. In some implementations, the first message may include an RRC Connection Request message, the second message may include an RRC Connection Setup message, and the third message may include an RRC Connection Setup Complete message.

In some implementations, the first message may include an RRC Connection Resume Request message, the second message may include an RRC Connection Resume message, and the third message may include an RRC Connection Resume Complete message.

In some implementations, the first message may include an RRC Connection Resume Request message, the second message may include an RRC Connection Setup message, and the third message may include an RRC Connection Setup Complete message.

In some implementations, the first message may include an RRC Connection Early Data Request message, and the second message may include an RRC Early Data Complete message.

In some implementations, the first message may include an RRC Connection Resume Request message plus uplink data, and wherein the second message may include an RRC Connection Release message.

In some implementations, the first message may include an RRC Early Data Request message, the second message may include an RRC Connection Setup message, and the third message may include an RRC Connection Setup Complete message.

In some implementations, the first message may include an RRC Connection Resume Request message plus uplink data, the second message may include an RRC Connection Resume message, and the third message may include an RRC Connection Resume Complete message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
communicating, by a processor of a user equipment (UE), a with a network node of a wireless network, the communicating involving:
transmitting, by the processor, a first message to the network node;
receiving, by the processor, a second message from the network node responsive to the transmitting of the first message; and
determining, by the processor, whether to transmit a third message to the network node acknowledging receipt of the second message.

2. The method of claim 1, further comprising:
transmitting, by the processor, the third message comprising a confirm message confirming receipt of the second message responsive to a result of the determining indicating a request information element (IE) or a format in the second message.

3. The method of claim 2, wherein the transmitting of the third message comprises transmitting the third message further responsive to the result of the determining also indicating that there is insufficient space in the first message to carry a piece of information requested in the request IE in addition to the confirm message.

4. The method of claim 1, further comprising:
transmitting, by the processor, the third message comprising a confirm message confirming receipt of the second message responsive to a result of the determining indicating a need for an uplink (UL) transmission to the network node.

5. The method of claim 4, wherein the transmitting of the third message comprises transmitting the third message further responsive to the result of the determining also indicating that there is sufficient space in the third message to carry data, higher-layer signaling, or both, in addition to the confirm message.

6. The method of claim 4, wherein the transmitting of the third message comprises transmitting the third message responsive to the result of the determining indicating the need for the UL transmission due to the UE connecting to another network node that is connected to a different part of the wireless network.

7. The method of claim 1, further comprising:
transmitting, by the processor, the third message comprising a confirm message confirming receipt of the second message responsive to a result of the determining indicating it necessary to transmit the third message.

8. The method of claim 7, wherein the first message comprises a radio resource control (RRC) Connection Request message, wherein the second message comprises an RRC Connection Setup message, and wherein the third message comprises an RRC Connection Setup Complete message.

9. The method of claim 7, wherein the first message comprises a radio resource control (RRC) Connection Resume Request message, wherein the second message comprises an RRC Connection Resume message, and wherein the third message comprises an RRC Connection Resume Complete message.

10. The method of claim 7, wherein the first message comprises a radio resource control (RRC) Connection Resume Request message, wherein the second message comprises an RRC Connection Setup message, and wherein the third message comprises an RRC Connection Setup Complete message.

11. The method of claim 7, wherein the first message comprises a radio resource control (RRC) Early Data Request message, wherein the second message comprises an RRC Connection Setup message, and wherein the third message comprises an RRC Connection Setup Complete message.

12. The method of claim 7, wherein the first message comprises a radio resource control (RRC) Connection Resume Request message plus uplink data, wherein the second message comprises an RRC Connection Resume message, and wherein the third message comprises an RRC Connection Resume Complete message.

13. The method of claim 1, wherein the first message comprises a radio resource control (RRC) Early Data Request message, and wherein the second message comprises an RRC Early Data Complete message.

14. The method of claim 1, wherein the first message comprises a radio resource control (RRC) Connection Resume Request message plus uplink data, and wherein the second message comprises an RRC Connection Release message.

15. An apparatus, comprising:
a transceiver capable of wirelessly communicating with a network node of a wireless network; and
a processor coupled to the transceiver, the processor capable of:
transmitting, via the transceiver, a first message to the network node;
receiving, via the transceiver, a second message from the network node responsive to the transmitting of the first message; and
determining whether to transmit a third message to the network node acknowledging receipt of the second message.

16. The apparatus of claim 15, wherein the processor is further capable of:
transmitting, via the transceiver, the third message comprising a confirm message confirming receipt of the second message responsive to a result of the determining indicating a request information element (IE) or a format in the second message,
wherein in transmitting the third message the processor is capable of transmitting the third message further responsive to the result of the determining also indicating that there is insufficient space in the first message to carry a piece of information requested in the request IE in addition to the confirm message.

17. The apparatus of claim 15, wherein the processor is further capable of:
transmitting, via the transceiver, the third message comprising a confirm message confirming receipt of the second message responsive to a result of the determining indicating a need for an uplink (UL) transmission to the network node.

18. The apparatus of claim 17, wherein in transmitting the third message the processor is capable of performing either:
transmitting the third message further responsive to the result of the determining also indicating that there is sufficient space in the third message to carry data, higher-layer signaling, or both, in addition to the confirm message; or
transmitting the third message responsive to the result of the determining indicating the need for the UL transmission due to the UE connecting to another network node that is connected to a different part of the wireless network.

19. The apparatus of claim 17, wherein the processor is further capable of:
transmitting, via the transceiver, the third message comprising a confirm message confirming receipt of the second message responsive to a result of the determining indicating it necessary to transmit the third message,
wherein the first message comprises a radio resource control (RRC) Connection Request message, wherein the second message comprises an RRC Connection Setup message, and wherein the third message comprises an RRC Connection Setup Complete message.

20. The apparatus of claim 15, wherein the first message comprises a radio resource control (RRC) Connection Early Data Request message, and wherein the second message comprises an RRC Early Data Complete message.
